(19) United States
(12) Patent Application Publication
(10) Pub. No.: US 2005/0056378 A1
(43) Pub. Date: Mar. 17, 2005

(54) Apparatus for unrolling a web of backing material on a roll with double-sidedly adhesive tape sections

(75) Inventor: Michael Schwertfeger, Hamburg (DE)

Correspondence Address: NORRIS, MCLAUGHLIN & MARCUS, 875 THIRD AVE, 18TH FLOOR, NEW YORK, NY, 10022, US

(73) Assignee: tesa AG, Hamburg (DE)

(21) Appl. No.: 10/705,140

(22) Filed: Nov. 11, 2003

(30) Foreign Application Priority Data
Nov. 20, 2002 (DE) 102 54 288.0

(51) Int. Cl. B65C 11/00

(52) U.S. Cl. 156/584

(57) ABSTRACT

Apparatus 100 for unrolling a web of backing material located on a roll 4 and bearing in particular double-sidedly adhesive tape sections 42 includes a handle element 1 fitted on a holding plate 2, mounted rotatably on the holding plate 2, a receiving roller 21 for the roll 4 of backing material web 41, mounted rotatably on the holding plate 2, a pressure roller 22 which brings the backing material web 41 with the adhesive tape sections 42 into contact with the substrate during the dispensing operation and is guided via the receiving roller 21 for the roll 4 in such a way that the adhesive tape sections 42 are dispensed from the backing material web 41 onto the substrate during the dispensing operation, mounted rotatably on the holding plate 2, a drive roller 23, via which the backing material web 41 with the adhesive tape sections 42 is guided such that the drive roller 23 rotates synchronously with the speed of the backing material web 41, mounted rotatably on the holding plate 2, a collecting roller 25, which receives the backing material web 41 after the adhesive tape sections 42 have been dispersed and which in particular is set in rotation via a belt 24 by the movement of the drive roller 23.

### RELATED APPLICATIONS

The benefit of priority of the German patent application number 102 54 288.0 filed on Nov. 20, 2002 in the name of the inventor, is hereby claimed.

### BACKGROUND OF THE INVENTION

1. Field of the Invention

The present invention relates to an apparatus for unwinding a web of backing material on a roll, the said material bearing self-adhesive die-cuts; especially double-sidedly self-adhesive die-cuts.

2. Description of the Related Art

Parts to be affixed using a double-side adhesive tape (for example, ribbon cables, displays, and cardboard packaging) are very often made completely self-adhesive beforehand. This consumes a large amount of material, and not only the task of providing parts with an adhesive tape with edge-to-edge matching but also the necessary task of removing the adhesive tape liner later on, during assembly, are very time-consuming.

One alternative is to apply individual spots of adhesive directly in the course of assembly and then to bond the part to them subsequently. This is also a laborious job, since the spots of adhesive again are provided with a liner, which has to be removed beforehand.

Certain parts (for example, electronic components or seals in mobile telephones) necessitate, depending on the specific application, the use of double-sidedly adhesive die-cuts. These die-cuts are individual sections of adhesive tape which are located on a backing web, following one another either immediately or at a predetermined distance, which may be regular or irregular.

Further applications of double-sidedly adhesive die-cuts of this kind are to be found in the automobile sector. One notable example is the bonding of ribbon cables in automobile roof linings.

These die-cuts have to be converted to the required shape beforehand in a die-cutting operation, in particular in an operation known as kiss-cutting, necessarily preceded by the lining of the adhesive tape for producing the die-cuts with an anti-adhesive material.

A feature of the kiss-cut process is that, in the course of die-cutting, the anti-adhesive material remains unpunched or uninjured, or substantially so.

This prevents adhesive from the die-cuts running into the incisions after die-cutting and sticking to the material. Were that to happen, downstream production steps in which the material is to be processed further together with the die-cuts could be affected by splitting of the material. That would exclude the entire roll from further processing, and hence it would become a waste product.

### SUMMARY OF THE INVENTION

It is an object of the invention to provide an apparatus combining great simplicity of construction, in a similar way to the kind of manual labelling device used to apply price labels, for example, with the ability to process a backing material web with in particular double-sidedly adhesive tape sections or die-cuts in order thus to allow individual adhesive tape sections to be applied directly and very quickly to any substrate and subsequently the direct bonding of any part to the said sections.

This object is achieved by an apparatus as set out in the independent claim. Developments of the apparatus of the invention are the subject-matter of the dependent claims.

Accordingly the apparatus for unrolling a web of backing material located on a roll and bearing in particular double-sidedly adhesive tape sections is composed of
a handle element fitted on a holding plate;
mounted rotatably on the holding plate, a receiver for the roll of backing material web,
mounted rotatably on the holding plate, a pressure roller which brings the backing material web with the adhesive tape sections into contact with the substrate during the dispensing operation and via which the backing material web with the adhesive tape sections is guided by the receiver for the roll such that in the course of the dispensing operation the adhesive tape sections are dispensed from the backing material web onto the substrate,
mounted rotatably on the holding plate, a drive roller, via which the backing material web with the adhesive tape sections is guided such that the drive roller rotates synchronously with the speed of the backing material web,
mounted rotatably on the holding plate, a receiving roller, which receives the backing material web after the adhesive tape sections have been dispensed and which in particular is set in rotation via a belt by the movement of the drive roller.

In one preferred embodiment the drive roller is disposed between the receiver for the roll of backing material web and the pressure roller.

In another preferred embodiment a guide roller is disposed between the receiver for the roll of backing material web and the drive roller, so as to produce a very high wraparound angle of the backing material web around the drive roller.

This ensures secure transmission of the movement of the backing material web to the drive roller and hence, via the preferred belt, to the receiving roller.

With further preference, on an arm which can be arrested on the handle element, there is an adjustable positioning aid, in particular in the form of a rotatably mounted shaft which can be fixed by screwing, and via which the backing material web is guided from the receiver for the roll of backing material web in the direction of the drive roller.

This positioning aid, composed in particular of a shaft which can be guided moveably in a groove and which can be screwed tight in any desired position within the groove serves to ensure that, in accordance with the particular application of the adhesive tape sections, the beginning and/or the end of the particularly double-sidedly adhesive tape sections is always at a predetermined point, so that the bond always begins in a defined manner at the beginning of an adhesive tape section with a length, for example, of 15 mm and ends after the dispensing operation, i.e., for example, when the apparatus has been passed once across the roof of an automobile, at the end of another adhesive tape section with a length, for example, of 15 mm.

Another exemplary solution for a positioning aid of this kind can be an additional small lens with marking, which can be positioned in the same way.

The distance between pressure roller and positioning aid is individually adjustable, adapted to the length of the particularly double-sidedly self-adhesive tape sections.

This positioning aid enables the apparatus' users to remain continuously within the relationship determined by the length of the adhesive tape sections.

In order to make it easy for both left-handers and right-handers to use the apparatus, the handle element and all other components can be mounted in mirror-image form on the holding plate.

In another preferred version in the receiver for the roll of backing material web there is an adjustable brake, in particular a friction brake. This ensures a uniform, not excessively low tension in the backing material web during the dispensing operation.

In a further preferred embodiment one side of the pressure roller is fixed on the holding plate and its other side carries a counterplate. The counterplate and the holding plate are of prolonged design in the direction of the handle is the case of the apparatus which is pushed during the dispensing operation. In terms of their shape, the counterplate and the holding plate are harmonized with the pressure roller and with the lever arm of the handle in such a way that at the end of the dispensing operation the entire apparatus can easily be tilted by the user about the fulcrum resulting from this geometry. As a result of this rotational movement it is on the one hand continuously possible, in conjunction with the positioning aid, to dispense even the last adhesive tape section reliably, i.e., to transfer it from the backing material web to the substrate; on the other hand, the following adhesive tape section, which is not to be adhered until later, is still held securely on the backing material web.

Suitable materials for the components include plastics, although a realization in metal is also possible.

Finally, the invention also provides an apparatus in conjunction with a backing material web which is located on a roll and bears particularly double-sidedly adhesive tape sections.

In a further embodiment, an apparatus of the invention for unrolling can be moved, instead of by a manual movement, alternatively by means of a customary automatic handler. In this case not only a conventional optical/electrical positioning aid but also, preferably, a mechanical/electrical positioning aid can be used, as follows.

The rotatable shaft adjustable in the groove possesses an additional shaft which is connected to it mechanically and takes the form, for example, of a toothed wheel which engages in a free edge region of the backing material web that is not covered over by the adhesive tape sections. As a result it is no longer possible to depart from the relationship—that is, the precise distance between positioning aid and pressure roller—once it has been manually set. In that case a conventional rotary encoder fixed mechanically on the shaft of the toothed wheel is used to trigger the automatic handler: that is, to initiate the start and end of the movement needed for the dispensing operation.

The apparatus of the invention is suitable for unwinding backing material which is present on a roll and which bears self-adhesive tape sections or die-cuts, particularly double-sidedly self-adhesive die-cuts.

These die-cuts are produced in a converting operation in which the backing material is overlaid with a single-sidedly or double-sidedly adhesive tape from which die-cuts are punched, in particular in a kiss-cut operation.

Especially when the backing material is intended for the enveloping of single-sidedly adhesive tapes it is quite sufficient for the backing material to be provided with an anti-adhesive coating on the side that is to be enveloped.

The material is preferably in the form of a backing material web on which double-sidely self-adhesive tape sections are disposed, both sides of the backing material web bearing an anti-adhesive coating, with the two anti-adhesive coatings differing in the degree of repulsion to the adhesive of the adhesive tape sections.

In one advantageous embodiment the anti-adhesive coating on the upper side of the backing material web has a lower degree of repulsion than the anti-adhesive coating on the lower side of the backing material.

The adhesive tape sections in this case are located on the top face when the backing material web is in the unrolled state.

This ensures that
the individual adhesive tape sections can be produced and made available on the backing material web in the form of a roll without further means (for example, a second liner); in the converting operation (the cutting to size of the adhesive tape sections) the excess material can be stripped off as a lattice and discarded; and
the adhesive tape sections can be dispensed with ease by the apparatus of the invention.

As the backing material web it is preferred to use paper, a paper-polyolefin composite and/or a film.

Suitable backing material further includes, in principle, films such as BOPP or MOPP, for example, PET, PVC or non-wovens (based on cellulose or polymers). Also suitable, furthermore, are foams (for example PU, PE, PE/EVA, EPDM, PP, PE, silicone, etc) or release papers (kraft papers, polyolefin-coated papers) or release films (PET, PP or PE or combinations of these materials) as substrates for coating.

As the anti-adhesive coating it is preferred to use a solventlessly coated silicone. With further preference the anti-adhesive coating and/or the solventlessly coated silicone is applied at from 0.8 to 3.7 g/m², more preferably from 1.3 to 3.2 g/m², very preferably from 1.8 to 2.8 g/m².

However, solventborne systems as well are possible as an anti-adhesive coating, at an application rate of in particular from 0.3 to 1 g/m².

As backings for the adhesive tape sections it is preferred, moreover, to use materials in web form such as paper, non-wovens, polymer films and foams.

In principle all kinds of double-faced adhesive tapes are suitable base material for the adhesive tape sections.

As adhesives for the adhesive tapes it is possible to use all pressure sensitive adhesives, as mentioned for example in SATAS, Handbook of Pressure Sensitive Adhesive Technology, Third Edition. Particularly suitable are natural/synthetic rubber-based and acrylate-based adhesives which can be applied from the melt or from solution.

In accordance with the invention it is additionally possible as backing material to use highly compacted glassine papers provided on the top and/or bottom side with a polymeric coating, with an anti-adhesive coat, in particular a silicone coating, applied to at least one of the two polymeric coatings present where appropriate.

In a further embodiment of the invention a paper backing with a density of from 1.1 to 1.25 g/cm³ is used as backing material, the paper backing having essentially a top side and a bottom side.

On the top and/or bottom side the paper backing is provided with a polymeric coating, an anti-adhesive coat being applied at least to one of the two polymeric coatings present where appropriate.

The paper backing or glassine paper preferably has a density of from 1.12 to 1.2 g/cm³, in particular from 1.14 to 1.16 g/cm³.

With further preference the paper backing or glassine paper has a base weight of from 40 to 120 g/m², more preferably from 50 to 110 g/m², very particularly from 60 to 100 g/m².

As the polymeric coating use is made in particular of polyolefins such as LDPE, HDPE, mixtures of the above two, for example, MDEP, PP or PET. LDPE is especially advantageous.

The poly-coated sides of the paper backing, comprising LDPE or HDPE, can additionally be produced in matt or glossy versions.

With further preference the polymeric coating is applied at from 5 to 30 g/m², more preferably from 10 to 25 g/m², very preferably from 15 to 20 g/m². In the case of polyester in particular the application can be made at just 2 to 3 g/m².

Furthermore, the invention is outstandingly embodied when, for example, silicone, paraffin, Teflon or waxes are used as anti-adhesive coats. In that case it is possible to use silicone-free release coats, for example, “non Silicone” from Rexam, or low-silicone release coats, for example, “Lo ex” from Rexam.

Depending on the specific paper backing material employed it is possible to make the anti-adhesive coats equally or differently releasing on either side of the backing material; that is, to set different release properties on either side (controlled release).

Preference is given to using solventlessly coated silicone.

With further preference the solventlessly coated silicone is applied at from 0.8 to 3.7 g/m², more preferably from 1.3 to 3.2 g/m², very preferably from 1.8 to 2.8 g/m².

Solventborne systems are also possible, however, with an application rate of in particular from 0.3 to 1 g/m².

In this way it is ensured that in the case of double-sided poly-coating the liner material has
dimensionally stable properties (good flatness)
a low thickness with high consistency of thickness (narrow tolerances, more precise die-cuts)
and a coat which protects against cuts to the paper body
   or that in the case of single-sided poly-coating the liner material has
a low thickness with high consistency of thickness (narrow tolerances, more precise die-cuts) and
a coat which protects against cuts to the paper body.

For use in the apparatus of the invention it is particularly advantageous if the individual adhesive tape sections are arranged in the form of rectangles on the backing material web. It is further very advantageous if these rectangles are arranged on the backing material web with no distance between the individual adhesive tape sections.

The production of such adhesive tape sections on a backing material web without a distance is often very difficult owing to the coalescence of the adhesive.

Additionally, therefore, it is possible with preference to use a backing material web on which die-cuts are arranged that are composed of a pressure sensitive adhesive possessing anisotropic properties.

In the course of the production, further possessing, or subsequent stressing of polymers or polymer compositions it is possible for high degrees of orientation of the macromolecules in preferential directions to develop throughout the polymer assembly; as a result of this orientation, which may also be induced deliberately, it is possible to control the properties of the corresponding polymers and to improve them in line with desired utilities. Anisotropically orientated pressure sensitive adhesives possess the tendency to move back into the initial state following stretching in a given direction, as a result of their “entropy-elastic” behavior.

Suitable in principle for use are all pressure sensitive adhesives which exhibit an orientation, examples being those based on natural rubbers and synthetic rubbers such as butyl rubber, neoprene, butadiene-acrylonitrile, styrene-butadiene-styrene, and styrene-isoprene-styrene copolymers, and also those based on linear polyesters and copolyesters, polyurethanes, polysiloxane elastomers, and those based on straight acrylics, but, very particularly, polyacrylate-based anisotropic pressure sensitive adhesives.

Acrylic PSAs of this kind with anisotropic orientation in the form of a layer, exhibit recession of the PSA film at the cut and punched edge following punching and/or cutting operations, and this recession can be utilized for the die-cutting of shapes which do not coalesce again.

One advantageous further development uses a pressure sensitive adhesive
which is obtainable by a free-radical polymerisation,
which is based to an extent of at least 65% by weight on at least one acrylic monomer from the group of the compounds of the following general formula: 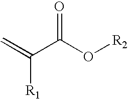
   where R₁═H or CH₃ and the radical R₂═H or CH₃ or is chosen from the group of the branched or unbranched, saturated alkyl groups having 2 to 20, preferably having 4 to 9, carbon atoms, the average molecular weight of the pressure sensitive adhesive being at least 650 000, and which, when applied to a backing, possesses a preferential direction, the refractive index measured in the preferential direction, n_{MD}, being greater than the refractive index measured in a direction perpendicular to the preferential direction, n_{CD}, and the difference Δn=n_{MD}−n_{CD} being at least 1×10⁻⁵.

Nonexclusive examples of alkyl groups which can be employed preferentially for the radical R₂ include butyl, pentyl, hexyl, heptyl, octyl, isooctyl, 2-methylheptyl, 2-ethylhexyl, nonyl, decyl, dodecyl, lauryl, and stearyl (meth)acrylate or (meth)acrylic acid.

Furthermore, the punching process proceeds excellently when a PSA is used which is based to an extent of up to 35% by weight on comonomers in the form of vinyl compounds, especially on one or more vinyl compounds chosen from the following group:
vinyl esters, vinyl halides, vinylidene halides, nitriles of ethylenically unsaturated hydrocarbons.

In accordance with the utility, acrylic compounds having functional groups are also embraced by the term “vinyl compound”. Vinyl compounds of this kind containing functional groups are maleic anhydride, styrene, styrene compounds, vinyl acetate, (meth)acryamides, N-substituted (meth)acryamides, β-acryloyloxypropionic acid, vinyl acetic acid, fumaric acid, crotonic acid, aconitic acid, dimethylacrylic acid, trichloroacrylic acid, itaconic acid, vinyl acetate, hydroxyalkyl (meth)acrylate, amino-containing (meth)acrylates, hydroxy-containing (meth)acrylates, especially 2-hydroxythyl (meth)acrylates, 2-hydroxypropyl (meth)acrylates, and/or 4-hydroxybutyl (meth)acrylate, and double-bond-functionalized photoinitiators; the above list is only exemplary and not conclusive.

For the PSAs is it especially advantageous if the composition of the corresponding monomers is chosen so that the resultant adhesives possess pressure sensitive adhesive properties in accordance with D. Satas [Handbook of Pressure Sensitive Adhesive Technology, 1989, VAN NOSTRAND REINHOLD, New York]. For this purpose the glass transition temperature of the acrylic PSA should be, for example, below 25° C.

The PSAs employed for the utility, especially the polyacrylate PSAs praised above for their advantage, are prepared preferably by a free-radically initiated polymerization. A process very suitable for this purpose is distinguished by the following steps:
polymerization of a mixture containing at least one vinyl-, acrylic- or methacrylic-based monomer or a combination of these monomers, the average molecular weight of the polymers formed being above 650 000,
subsequent extrusion coating of the polymer composition,
subsequent crosslinking of the polymer composition on the backing by irradiation with electron beams.

The extrusion coating in this case takes place preferably through an extrusion die. The extrusion dies used may originate from one of the three following categories: T-dies, fishtail dies, and coathanger dies. The individual types differ in the design of their flow channel. In order to produce orientated acrylic PSAs, it is particularly preferred to carry out coating onto a backing using a coathanger die, specifically in such a way that a polymer layer is formed on the backing by means of a movement of die relative to backing.

The time which elapses between coating and crosslinking is advantageously very short, preferably not greater than 10s.

The shaping of the acrylic hotmelt in the coathanger die and its emergence from the die with a defined film thickness, the orientation of the PSA film on transfer to the backing material, to give a lower film thickness, and the subsequent inline crosslinking produce the orientation.

The free radical polymerization can be conducted in the presence of an organic solvent or in the presence of water or in mixtures of organic solvents and water or without solvent. It is preferred to use as little solvent as possible. The polymerization time, depending on conversion and temperature, is between 6 and 48 h.

In the case of solution polymerization it is preferred as solvents to use esters of saturated carboxylic acids (such as ethyl acetate), aliphatic hydrocarbons (such as n-hexane or n-heptane), ketones (such as acetone or methyl ethyl ketone), special-boiling-point spirit or mixtures of these solvents. For polymerization in aqueous media or in mixtures of organic and aqueous solvents, it is preferred to add the emulsifiers and stabilizers which are known to the skilled worker for this purpose to the polymerization. Polymerization initiators used are customary radical-forming compounds such as peroxides, azo compounds, and peroxosulfates, for example. Initiator mixtures as well can be used. During polymerization it is possible to use further regulators for reducing the molecular weight and lowering the polydispersity. As so-called polymerization regulators it is possible, for example, to use alcohols and ethers. The molecular weight of the acrylic PSAs is advantageously between 650,000 and 2 000 000 g/mol, more preferably between 700 000 and 1 000 000 g/mol.

In a further procedure the polymerization is conducted in polymerization reactors which in general are provided with a stirrer, two or more feed vessels, reflux condenser, heating and cooling and which are equipped for operation under N₂ atmosphere and superatmospheric pressure.

Following the polymerization in solvent, the polymerization medium can be removed under reduced pressure, this operation being conducted at elevated temperatures in the range, for example, of from 80 to 150° C. The polymers can then be used in the solvent-free state, particularly as hotmelt PSAs. In certain cases it is also an advantage to prepare the polymers of the invention without solvent.

In order to prepare the acrylic PSAs, the polymers may undergo conventional modification. By way of example it is possible to add tackifying resins, such as terpene resins, terpene-phenoic resins, C5, C9 and C5/C9 hydrocarbon resins, pinene resins, indene resins or rosins, alone or in combination with one another. It is also possible, furthermore, to use plasticizers, various fillers (for example, fibres, carbon black, zinc oxide, titanium dioxide, solid microbeads, solid or hollow glass beads, silica, silicates, chalk, blocking-free isocyanates, etc), aging inhibitors, light stabilizers, ozone protectants, fatty acids, plasticizers, nucleators, blowing agents and/or accelerators as additives. In addition it is possible to admix crosslinkers and crosslinking promoters. Examples of suitable crosslinkers for electron beam crosslinking are difunctional or polyfunctional acrylates, difunctional or polyfunctional isocyanates or difunctional or polyfunctional epoxides.

The straight or blended acrylic hotmelts are coated onto the backing material through a die with a variable slot width and are then cured on the backing using electron beams. Crosslinking takes place in inline operation immediately after the PSA has been applied to the backing.

The backing material is preferably used with double-sidedly adhesive die-cuts for the bonding of components in electronic devices such as telephones, especially mobile telephones.

With further particular advantage the backing material web can be used for bonding individual parts in automotive construction, or else for example in exhibition stand construction, or in the packaging sector.

The inventive combination of the apparatus and the backing material web affords a multiplicity of advantages of a kind which could not have been foreseen.

During the dispensing of the adhesive tape sections no time is lost through removal of a liner, and there is less waste. Difference sizes of the adhesive tape sections—adhered in different numbers—allow the required amount of adhesive tape to be “dosed” so to speak.

An apparatus of the invention preferably uses double-sidedly self-adhesive tape sections which are arranged without a gap on the backing material web; i.e., for example, a double-sidedly self-adhesive tape 15 mm wide with a transverse separation every 15 mm.

An adhesive stretch of 90 mm, for example, is therefore replaced by a quantity of 6 adhesive tape sections each of 15 mm. Other, arbitrary dimensions are likewise conceivable.

By virtue of the adhesive tape sections 15 mm in length it is possible to bond an adhesive tape in curves with the aid of the apparatus of the invention, even when that adhesive tape is an inherently rigid, double-sidedly self-adhesive tape with carrier.

The apparatus exhibits an adjustable start and end marking, which enables the user to position any desired number of adhesive tape sections on the substrate.

The arrangement of all the functional elements is such that the dispensing operation can be carried out not only in the normal way, by pulling, but also, preferably, by a pushing movement.

Referring to the figures described below, particularly advantageous embodiments of the apparatus are elucidated in more detail, without thereby wishing to restrict the invention unnecessarily.

Other aspects of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1 shows the apparatus without a roll of the backing material web in one embodiment of particularly advantageous design,

FIG. 2 shows the apparatus of FIG. 1 with a roll of the backing material web,

FIG. 3 shows the apparatus of FIG. 1 without a roll of the backing material web, viewed from the left-hand side,

FIG. 4 shows the apparatus of FIG. 1 with a roll of the backing material web, viewed from the left-hand side, and

FIG. 5 shows a roll of the backing material web with adhesive tape sections.

### DETAILED DESCRIPTION OF THE PRESENTLY PREFERRED EMBODIMENTS

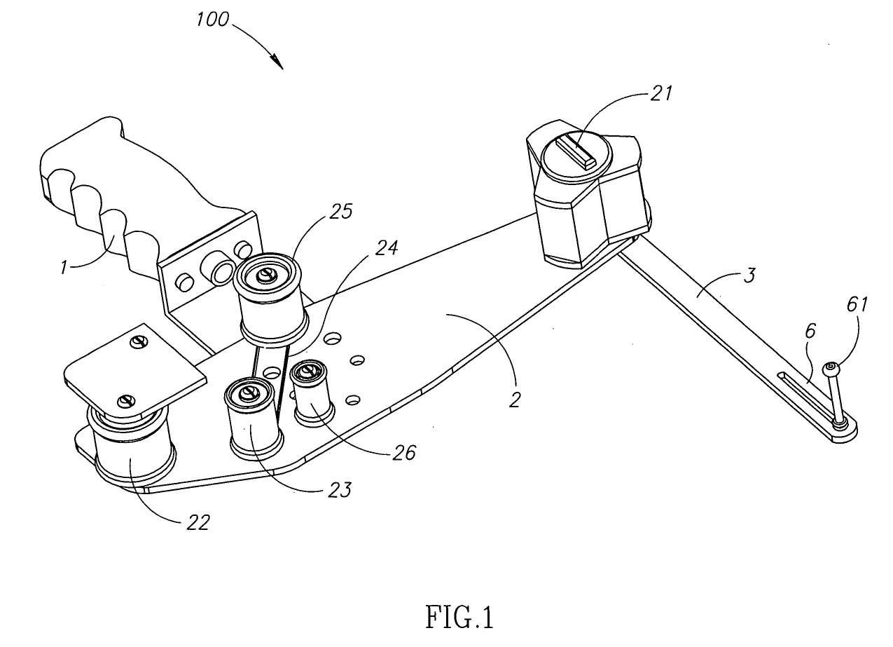

FIG. 1 shows the apparatus 100 for unrolling a web of backing material 41 on a roll 4, said web bearing particularly double-sidedly adhesive tape sections 42.

The apparatus 100 is composed of a number of individual components.

The central component is the holding plate 2 which serves to accommodate all of the other components—for instance, a handle element 1 which is screwed to the holding plate 2.

Simple positioning of the handle 1 allows a pulling movement and also in particular a pushing movement of the apparatus 100 during the dispensing operation. Preferably the apparatus 1 is pushed, since a greater pressing force, which is advantageous for pressure-sensitive self-adhesive compositions, can be applied ergonomically with substantially greater ease in the case of a pushing movement.

On the holding plate 2 there is then provided a rotatably mounted receiving roller 21 for the roll 4 of backing material web 41.

Also present is a pressure roller 22 which is mounted rotatably on the holding plate 2 and which during the dispensing operation brings the backing material web 41 bearing the adhesive tape sections 42 into contact with the substrate and is guided via 21 for the roller 4 such that the adhesive tape sections 42 are dispensed from the backing material web 41 to the substrate during the dispensing operation.

The material and diameter of the pressure roller 22 are such that on the one hand a sufficient applied pressure is ensured for the bonding of the self-adhesive tape sections 42 and on the other hand the backing material web 41 can be removed without problems from the double-sidedly self-adhesive tape sections 42 in the course of dispensing. In that case it is specially harmonized with the properties of the double-sidedly self-adhesive tape sections 42 on the backing material web 41.

By way of a drive roller 23 mounted rotatably on the holding plate 2 the backing material web 41 bearing the adhesive tape sections 42 is guided so that the drive roller 23 rotates synchronously with the speed of the backing material web 41.

The drive roll 23 is disposed between the receiving roller 21 for the roll 4 of backing material web 41 and the pressure roller 22.

So that the backing material web 41 exhibits a large angle of wrap around the drive roller a guide roller 26 is disposed between the receiving roller 21 for the roller 4 of backing material web 41 and the drive roller 23, and is in turn surrounded by the backing material web 41.

Finally there is on the holding plate 2 a rotatably mounted collecting roller 25 which receives the backing material web 41 after the adhesive tape sections 42 have been dispensed and which in particular is placed in rotation via a belt 24 through the movement of the drive roller 23.

Provided on an arrestable arm 3 on the holding device 2 is an adjustable positioning aid 6, specifically in the form of a rotatably mounted shaft 61 which can be screwed tight and via which the backing material web 41 is guided from the receiving roller 21 for the roll 4 of backing material web 41 in the direction of drive roller 23.

On one side the drive roller 23 is fixed to the holding plate 2 and on its other side it carries a counter plate 8. The counter plate 8 and the holding plate 2 have a prolonged design in the direction of the handle 1 in the case of the apparatus 100 which is pushed during the dispensing operation. In terms of their shape, the counter plate 8 and the holding plate 2 are harmonized with the pressure roller 22 and with the lever arm of the handle 1 in such a way that at the end of the dispensing operation the entire apparatus 100 can easily be tilted by the user about the fulcrum which results from this geometry. As a result of this rotary movement it is always possible in conjunction with the positioning aid 6 on the one hand to dispense the final adhesive tape section 42 reliably, i.e., transfer it from the backing material web 41 to the substrate, while on the other hand the adhesive tape section 42, which is not to be applied until later, is still held securely on the backing material web 41.

The entire apparatus 100 is harmonized in such a way that with the collecting roller 25 either full or empty there is no adverse effect on the accuracy with which the double-sidedly self-adhesive tape sections 42 are positioned. This relates in particular to the transmission ratio of the belt drive between the rollers 23 and 25.

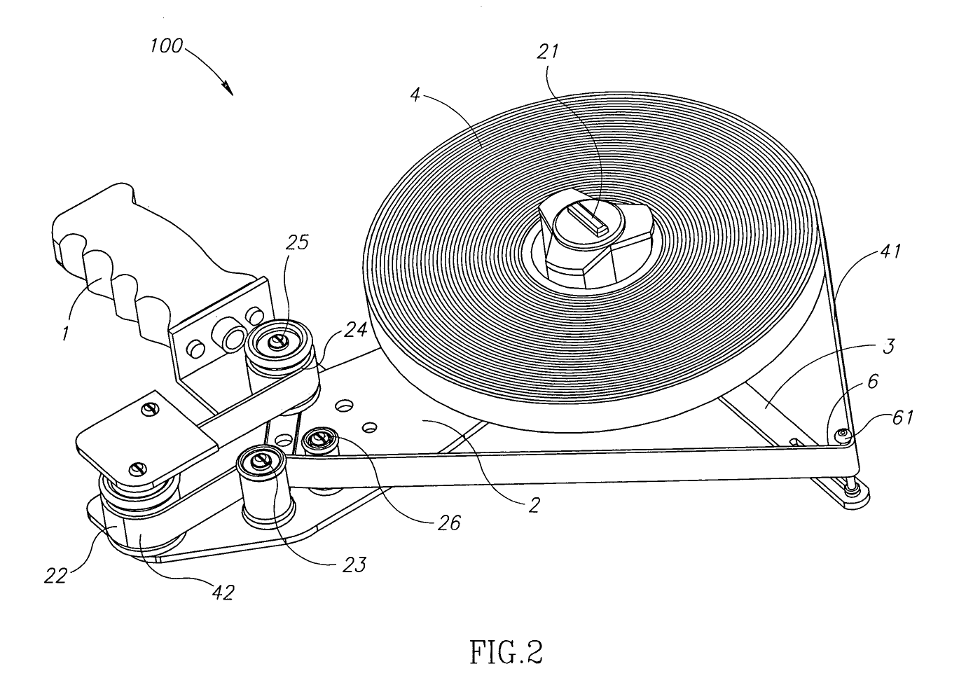

FIG. 2 shows the apparatus 100 according to FIG. 1 with a roll 4 of the backing material web 41. This figure is particularly illustrative of the guiding of the backing material web 41.

From the roll 4 the backing material web 41 runs via the positioning aid 6 to the guide roller 26, wraps around the drive roller 23, is guided to the pressure roller 22, at which the adhesive tape sections 42 are parted from the backing material web 41, while the backing material web 41 runs on to the collecting roller 25 and is wound up.

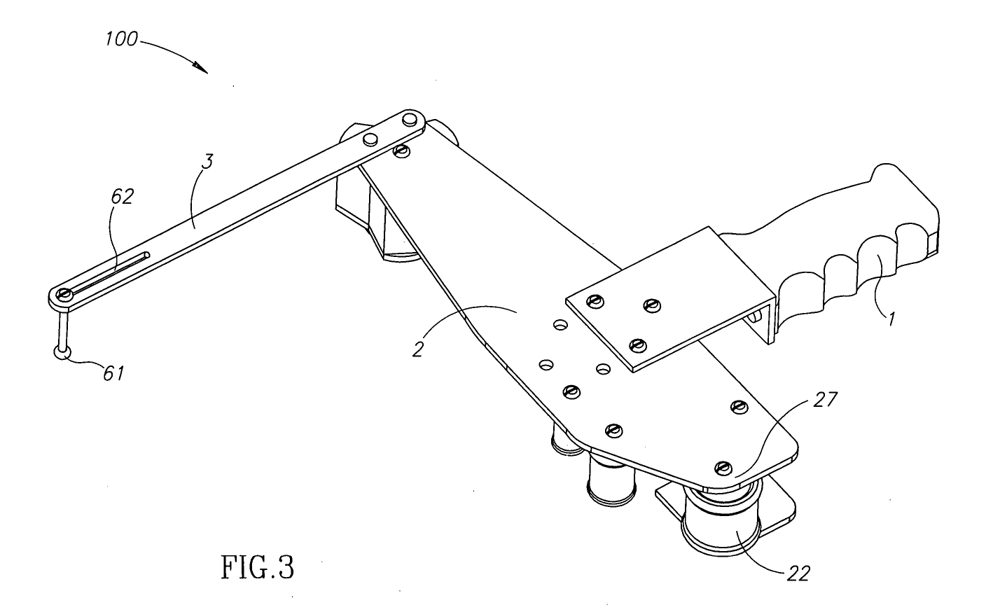

FIG. 3 shows the apparatus 100 of FIG. 1 without a roll 4 of the backing material web 41, viewed from the left-hand side.

The shaft 61 of the positioning aid 6 is guided displaceably within a groove 62, where it can be fixed by screwing.

A small pin 27 further facilitates the precise positioning of the pressure roller 22 on the substrate in the case of manual operation of the apparatus 100, i.e., the positioning of the start of the first adhesive tape section 42.

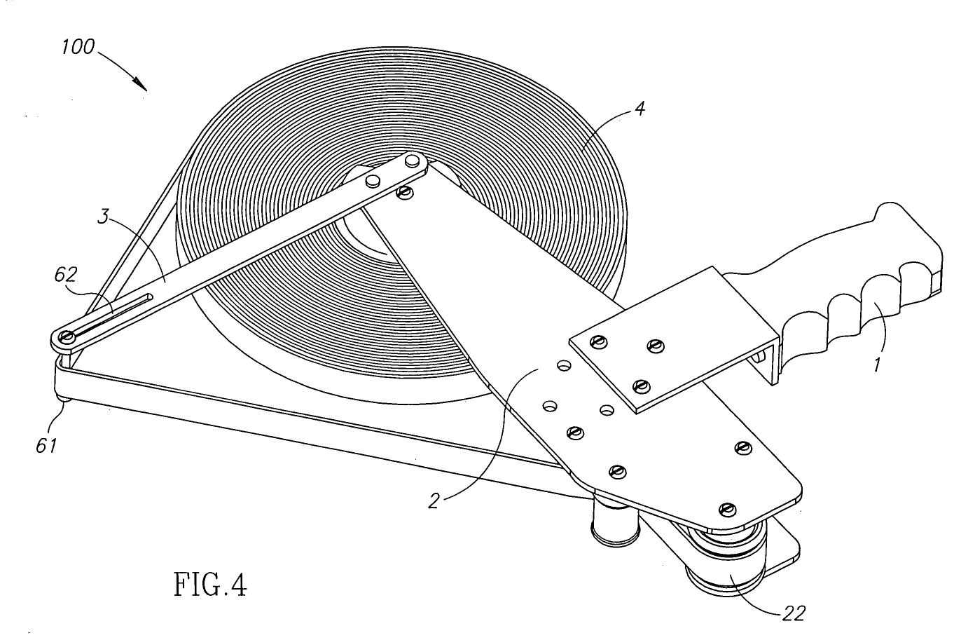

FIG. 4 again shows the apparatus 100 of FIG. 1 with a roll of the backing material web 41, viewed from the left-hand side.

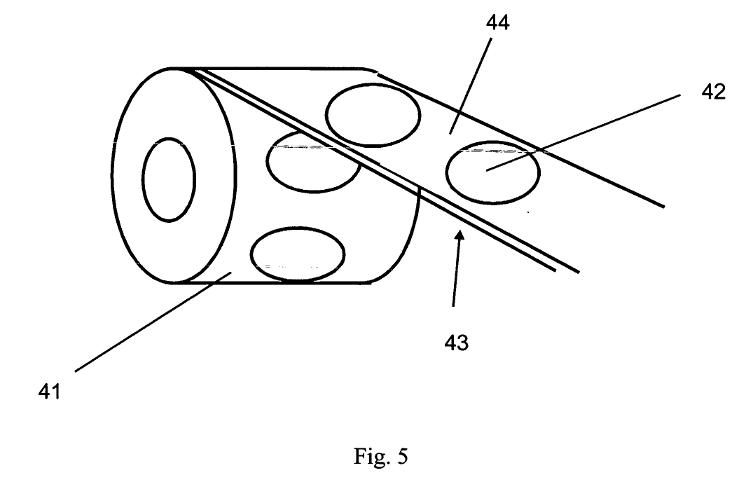

The backing material web 41 is wound up in accordance with FIG. 5 to form a roll in the form of an archimedean spiral. Disposed at regular intervals on the backing material web 41 are the individual adhesive tape sections 42, here in the form of circles.

The backing material web 41 has different anti-adhesive coatings 43, 44. The anti-adhesive coating 43 on the lower face of the backing material web 41 has a higher degree of repellence than the anti-adhesive coating 44 on the upper face of the backing material web 41.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. An apparatus 100 for dispensing a double-sided adhesive section from a roll of tape 4 comprising a backing material 41 and the double-sided adhesive material 42, the apparatus comprising
a holding plate 2;
a handle 1 mounted on the holding plate 2;
a receiving roller 21 for holding the roll of tape 4 comprising the backing material 41 and the double-sided adhesive material 42, the receiving roller 21 being rotatably mounted on the holding plate 2;
a drive roller 23 rotatably mounted on the holding plate 2;
a pressure roller 22 rotatably mounted on a holding plate 2;
a collecting roller 25 rotatably mounted on the holding plate 2;
the drive roller 23 and the collecting roller 25 are speed-synchronized by a belt drive; wherein the tape 4 including the double-sided adhesive material 42 and the backing material 41 is brought from the receiving roller 21 via the drive roller 23 to the pressure roller 22 and wherein the pressure roller 22 is positioned such that the double-sided adhesive material 42 may be brought into contact with a substrate, and upon contacting the substrate, the double-sided adhesive material 42 is separated from the backing material 41; and wherein the backing material 41 is rolled onto the collecting roller 25.

2. The apparatus according to claim 1, wherein the drive roller 23 is disposed between the receiving roller 21 and the pressure roller 22.

3. The apparatus according to claim 1, further comprising a guide roller 26 disposed between the receiving roller 21 and the drive roller 23.

4. The apparatus according to claim 1, further comprising an arm 3 extended from the holding plate 2, the arm 3 including an adjustable positioning aid 6 for position the tape 4.

5. The apparatus according to claim 1, wherein the holding plate is adapted such as to accommodate mountings for right handed or left handed users.

6. The apparatus according to ding claim 1, further comprising a friction brake associated with the receiving roller 21.

7. The apparatus according to claim 1, wherein the pressure roller 22 having two axial ends, one end being mounted to the holding plate 2 and the second end being mounted to a counter plate 8, the counter plate 8 and the holding plate 2 being elongated towards the handle 1, and provide guidance of the apparatus while dispensing.

8. The apparatus according to claim 1, wherein the adhesive tape material comprises sections.

9. The apparatus according to claim 4, wherein the adjustable positioning aid 6 is adjustable within an elongated groove 62 formed in the arm and wherein the positioning aid 6 is formed as a rotatably mounted shaft 61.
